(19) United States
(12) Patent Application Publication
(10) Pub. No.: US 2008/0246895 A1
(43) Pub. Date: Oct. 9, 2008

(54) Light diffusion element, screen, and image projector

(75) Inventors: Muneharu Kuwata, Tokyo (JP); Tomohiro Sasagawa, Tokyo (JP); Jun Someya, Tokyo (JP)

Correspondence Address: BIRCH STEWART KOLASCH & BIRCH, PO BOX 747, FALLS CHURCH, VA, 22040-0747, US

(73) Assignee: Mitsubishi Electric Corporation

(21) Appl. No.: 11/976,874

(22) Filed: Oct. 29, 2007

(30) Foreign Application Priority Data
Apr. 5, 2007 (JP) 2007-099782

(51) Int. Cl. G02F 1/1335; G02F 1/1333

(52) U.S. Cl. 349/5; 349/86

(57) ABSTRACT

A light diffusion element includes a liquid-crystal diffusion layer that variably diffuses an amount of light depending on an applied voltage, a first electrode that is laid on a plane of the light diffusion layer and made of a first and a second segmented-electrodes, a second electrode that is laid on the other plane of the light diffusion layer, a voltage applying unit that generates and applies two types of voltages, and a voltage changing unit that varies the two types of voltages. One of the voltages is applied between the first segmented-electrodes and the second electrode, and the other between the second segmented-electrodes and the second electrode. Both the segmented-electrodes are included in each pixel.

### BACKGROUND OF THE INVENTION

1. Field of the Invention

The present invention relates to a light diffusion element, a screen, and an image projector used to display an image.

2. Description of the Related Art

In recent years, along with the progress in the liquid crystal technology, various image displaying apparatuses are being developed. One of the image displaying apparatuses that uses liquid crystals is an image projector of rear-projection type. In an image projector of rear-projection type, the light from a light source is conveyed to an optical modulator via an illumination system. The light is modulated by the optical modulator, and modulated light is then projected from the rear side of a screen by using an optical system such as a lens or a mirror. As a result, an image is displayed on the screen. Such an image projector is widely implemented in consumer applications such as large-screen televisions or commercial applications such as information displays or advertising displays.

A white-light source such as a lamp is used as a light source in the image projector. The white light from the light source is spatially or temporally divided into the light of three primary colors of red (R), green (G), and blue (B). The light in each primary color is then subjected to optical modulation based on image signals and the modulated light in three primary colors is recombined to form a full-color image.

An illumination system in the image projector includes a light homogenizer that homogenizes light emitted from the light source, a light shaping unit that converts the light such that a cross-section of the light, which is usually elliptic, is shaped into rectangular able to fit in the optical modulator, a light dividing unit such as a color filter that divides the light that is white light into the three primary colors, and an optical element such as a lens or a mirror that forms an image of a desired size at a desired position by using the light.

The optical modulator in the image projector includes a reflective optical modulator such as Digital Micromirror Device (DMD) (registered trademark), and a transmissive liquid crystal panel or a reflective liquid crystal panel. Two methods of optical modulation are known. One is a three-chip optical modulation method in which white light emitted from a light source is spatially divided into the three primary colors. The light of each primary color is then subjected to optical modulation using a separate optical modulator. The other is a single-chip optical modulation method in which white light is temporally divided into the three primary colors by using a rotatable color filter arranged in the light path. The light of each primary color is then subjected to temporal optical modulation by using only one optical modulator.

A screen in the image projector of rear-projection type is configured to transmit the light projected from the rear surface of the screen and display the projected light as an image to a viewer on the front surface of the screen. The screen includes a Fresnel lens that deviates the projected light towards the viewer's side and a lenticular lens that widens in horizontal direction the viewing angle of the light deviated from the Fresnel lens. It is also possible to widen the viewing angle of the light in vertical direction by including a light diffusion layer in either or both of the Fresnel lens and the lenticular lens such that the projected light can be subjected to diffusion.

However, in such a conventional screen, the diffused light in the light diffusion layer interferes with each other. The interference causes scintillation effect, i.e., glares in the displayed image thereby failing to display a clear image.

Moreover, in recent years, to display an image more vivid than the image displayed on the conventional screen, an image projector is developed that uses three laser-light sources for separately emitting the light in the three primary colors. However, the light emitted from a laser-light source has a greater degree of parallelization or monochromaticity, and greater coherency. As a result, the laser light is very sensitive to any minute variation in the light diffusion characteristics caused by even a slight fluctuation in the light diffusion layer. That causes more scintillation effect than in the case of a conventional screen. Hence, it is all the more necessary to reduce the scintillation effect to obtain a clear image when using the laser-light sources.

A method to reduce the scintillation effect is disclosed in Japanese Patent Application Laid-Open No. 2001-100316 in which the light diffusion characteristics of a light diffusion layer are temporally varied. Another method to reduce the scintillation effect is disclosed in Japanese Patent Application Laid-Open No. 2005-352020 in which voltage is applied periodically to at least two liquid crystal layers in a light diffusing surface such that the light diffusing surface is subjected to a vibrating effect.

However, when the light diffusion characteristics of the light diffusion layer are temporally varied, the viewing angle of the light transmitting from the screen also varies depending on the amount of light diffusion. As a result, brightness of a displayed image keeps on varying depending on the direction from which the displayed image is viewed. As a result, the displayed image appears to be flickering. Moreover, when the above methods are implemented in a single-chip optical modulator, it is necessary to synchronize the timing of displaying the image and the timing of varying the light diffusion characteristics of the light diffusion layer. Not synchronizing the timing can cause unbalance of the brightness in the color image. Hence, it becomes difficult to control the light diffusion characteristics of the light diffusion layer. Furthermore, because it is necessary to use multiple liquid crystal layers in the above methods, the structure of the light diffusion element becomes complicated thereby increasing the production cost.

### SUMMARY OF THE INVENTION

It is an object of the present invention to at least partially solve the problems in the conventional technology.

According to an aspect of the present invention, there is provided a light diffusion element for use in a screen for displaying an image. The light diffusion element includes a liquid-crystal diffusion layer made of a high polymer containing liquid crystal molecules dispersed therein, the liquid crystal molecules variably diffusing an amount of light passing through the liquid-crystal diffusion layer depending on a voltage applied to the liquid-crystal diffusion layer; a first electrode that is laid on a first principle plane of the liquid-crystal diffusion layer and includes a first segmented-electrode and a second segmented-electrode, wherein the first segmented-electrode and the second segmented-electrode are included in each pixel of the image; a second electrode that is laid on a second principle plane of the liquid-crystal diffusion layer opposite to the first principle plane; a voltage applying unit that is configured to generate and apply a first voltage between the first segmented-electrode and the second electrode, and a second voltage between the second segmented-electrode and the second electrode; and a voltage changing unit that separately and temporally varies the first voltage and the second voltage.

According to another aspect of the present invention, there is provided a screen that displays an image by using a light projected on the screen. The screen includes the above light diffusion element.

According to still another aspect of the present invention, there is provided an image projector. The image projector includes a light source that emits a light; a light focusing unit that makes the light coming from the light source to be a substantially parallel light flux, and focuses the substantially parallel light flux on a target surface located on an axis of the substantially parallel light flux; an image projection unit that modulates and spreads the substantially parallel light flux focused on the target surface, and projects modulated and spread light; and the above screen.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a side view of an image projector according to a first embodiment of the present invention;

FIG. 2 is an enlarged perspective view of a display mechanism in the image projector shown in FIG. 1;

FIG. 3 is an enlarged side view of a polymer dispersed liquid crystal (PDLC) element of the display mechanism shown in FIG. 2;

FIG. 4 is a schematic diagram depicting a status of light diffusion when no voltage is applied to a liquid-crystal diffusion layer of the PDLC element shown in FIG. 3;

FIG. 5 is a schematic diagram depicting a status of light diffusion when a voltage is applied to the liquid-crystal diffusion layer of the PDLC element shown in FIG. 3;

FIG. 6 is an enlarged perspective view explaining the detailed structure of the PDLC element; and

FIG. 7 is a graph depicting an example of time waveforms when voltage is applied to segmented-electrodes that are laid on the liquid crystal layer shown in FIG. 3.

### DETAILED DESCRIPTION OF THE PREFERRED EMBODIMENTS

Exemplary embodiments of the present invention are described in detail below with reference to the accompanying drawings. The present invention is not limited to these exemplary embodiments.

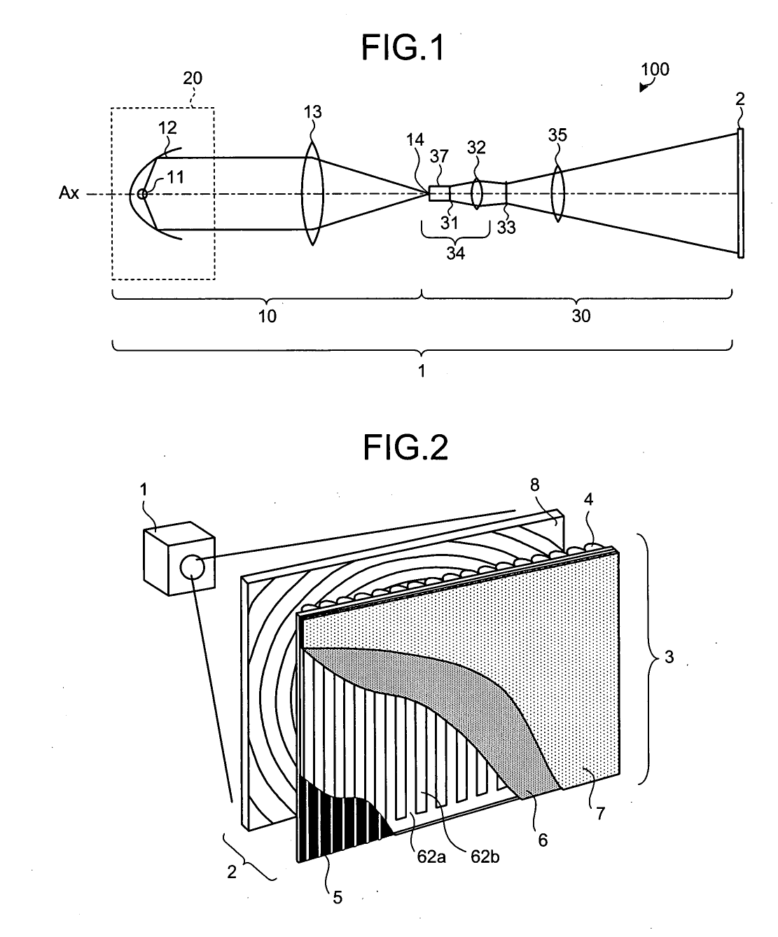

FIG. 1 is a side view of an image projector 100 according to a first embodiment of the present invention. The image projector 100 includes an optical engine 1 and a display mechanism 2 that is a screen for displaying images. The optical engine 1 is made of a light source device 10 and an image projection mechanism 30.

The light source device 10 includes a main light-source 20, a condenser lens 13, and a light-focus surface 14. The main light-source 20 includes a lamp-light source 11 that uses a supervoltage mercury lamp and a paraboloid reflector 12. In the main light-source 20, the light emitted from the lamp-light source 11 is reflected by the paraboloid reflector 12 to obtain a substantially parallel light flux. The parallel light is then conveyed to the condenser lens 13. In the image projector 100, the axis of the parallel light conveyed from the paraboloid reflector 12 is assumed to be a light axis Ax shown in FIG. 1.

The image projection mechanism 30 includes a light homogenizer 37 that homogenizes the light emitted from the light source device 10, a relay optical system 32 that conveys the light exiting from an exit surface 31 of the light homogenizer 37, an optical modulator 33 that modulates the light conveyed by the relay optical system 32, a projection optical system 35 that performs magnified projection of the light modulated by the optical modulator 33 on the display mechanism 2.

The light homogenizer 37 and the relay optical system 32 form an illumination system 34 for irradiating the light emitted by the light source device 10 to the optical modulator 33. The light homogenizer 37 is made of a light pipe with a reflection film covering its inner peripheral surface. The light pipe is a square-shaped pipe with its cross-sectional shape similar to the display area of the optical modulator 33. The light entering the light pipe (light homogenizer 37) from an entrance surface is subjected to total internal reflection at the reflection film inside the light pipe. After being subjected to the total internal reflection inside the light pipe, a light with uniform intensity distribution exits from the exit surface 31.

The relay optical system 32 is arranged between the light homogenizer 37 and the optical modulator 33. The relay optical system 32 forms an image by using the light exiting from the light homogenizer 37 such that the exit surface 31 of the light homogenizer 37 and the optical modulator 33 function as a unit.

The optical modulator 33 includes, for example, a reflective Digital Micromirror Device (DMD) (registered trademark), and a transmissive liquid crystal panel or a reflective liquid crystal panel. It is possible to use a single-chip optical modulator having only one unit of the optical modulator 33, or a multiple-chip optical modulator having multiple units of the optical modulator 33 (e.g., a three-chip optical modulator having three units of the optical modulator 33).

The projection optical system 35 is arranged between the optical modulator 33 and the display mechanism 2. The projection optical system 35 performs forms images by using the light exiting from the optical modulator 33 such that the optical modulator 33 and the display mechanism 2 function as a unit.

When the image projector 100 is of a rear-projection type, the display mechanism 2 functions as a transmission screen. In that case, the display mechanism 2 includes a Fresnel lens arranged next to and facing against the projection optical system 35 (refer to a Fresnel-lens screen 8 described later for details), and a lenticular lens arranged such that the Fresnel lens lies between the projection optical system 35 and the lenticular lens (refer to a lenticular lens 4 described later for details). The display mechanism 2 displays an image on a lenticular screen that projects images to a viewer (refer to a lenticular screen 3 described later for details). The Fresnel lens receives the projected light exiting from the projection optical system 35 and outputs it as a substantially parallel light. The lenticular lens 4 widens the viewing angle of the substantially parallel light exiting from the Fresnel lens by using a group of cylindrical lenses arranged in parallel, and projects that light with a wide viewing angle as an image onto the lenticular screen.

If the image projector 100 is of a front-projection type, the display mechanism 2 functions as a reflection screen. In that case, the display mechanism 2 has a substantial perfectly-diffused surface. The projected light exiting from the projection optical system 35 can be reflected as an image on the Fresnel-lens screen 8 after widening the viewing angle of the light.

The paraboloid reflector 12 converts the light emitting from the lamp-light source 11 into a substantially parallel light flux. The condenser lens 13 focuses the substantially parallel light flux on the light-focus surface 14, which is a part of the light source device 10 and arranged on the light axis Ax. The focused light enters the light homogenizer 37 from the entrance surface, which also happens to be the surface of the light-focus surface 14. The focused light then passes through the light homogenizer 37 and is homogenized by getting repeatedly reflected inside the light homogenizer 37. The homogenized light exits from the exit surface 31. The light exiting from the exit surface 31 is subjected to refraction and reflection in the relay optical system 32, and irradiated to the optical modulator 33. The optical modulator 33 modulates the irradiated light from the relay optical system 32 based on image signals that are input in the optical modulator 33. The projection optical system 35 magnifies the modulated light by subjecting the modified light to refraction and reflection, and projects the magnified light as an image on the display mechanism 2.

The light homogenizer 37 can be a square-shaped transparent rod integrator with its cross-sectional shape similar to the display area of the optical modulator 33. The light entering into the rod integrator (light homogenizer 37) from an entrance surface is subjected to total internal reflection at a side, which is an interface adjacent to the air layer, of the rod integrator. After being subjected to the total internal reflection inside the rod integrator, a light with uniform intensity distribution exits from the exit surface 31.

A color wheel for displaying a color image, a dichroic filter for transmitting or reflecting the light with a predetermined wavelength band, and a prism for combining lights with different wavelength bands can be arranged at any position either prior to the light-focus surface 14 (a side closer to the light source device 10) or subsequent to the exit surface 31 (a side closer to the display mechanism 2), that is, outside the light homogenizer 37.

In the above description, a supervoltage mercury lamp is used as the lamp-light source 11 in the main light source 20. However, it is possible to use another lamp such as a xenon lamp, a metal halide lamp, or an electrodeless discharge lamp as the lamp-light source 11. Furthermore, instead of using the paraboloid reflector 12, another reflector such as an ellipsoidal reflector can be used in the main light source 20. If an ellipsoidal reflector is used in the main light source 20, there is no need to use the condenser lens 13 in the light source device 10 because the light emitted from the lamp-light source 11 can be directly focused on the light-focus surface 14.

Given below is the description about the display mechanism 2. FIG. 2 is an enlarged perspective view of the display mechanism 2. The display mechanism 2 is a screen that displays images while reducing the scintillation effect (described later in detail) from the displayed images. The display mechanism 2 includes the Fresnel-lens screen 8 and the lenticular screen 3, which are flat screens of substantially rectangular shape and arranged such that their principal planes face each other.

The Fresnel-lens screen 8 includes a Fresnel lens and is arranged between the optical engine 1 and the lenticular screen 3. In the Fresnel-lens screen 8, the diffused light exiting from the projection optical system 35 is subjected to refraction and transmission, and a convergent light within a predetermined range of angle is output to the lenticular screen 3.

The lenticular screen 3 includes the lenticular lens 4, a black-stripes layer 5, a polymer dispersed liquid crystal (PDLC) element 6 that is a light diffusion element, and a light diffusion layer 7. The lenticular lens 4 lies on a surface of the lenticular screen 3 that is closest to the Fresnel-lens screen 8, while the light diffusion layer 7 lies on the other surface of the lenticular screen 3 that is farthest from the Fresnel-lens screen 8. The light diffusion layer 7 forms the outermost layer of the lenticular screen 3 on the viewer's side. The black-stripes layer 5 lies next to the lenticular lens 4 and farther from the Fresnel-lens screen 8. The PDLC element 6 lies between the black-stripes layer 5 and the light diffusion layer 7.

The convergent light exiting from the Fresnel-lens screen 8 is subjected to refraction and transmission by the lenticular lens 4 thereby widening the light within a suitable range of angle to secure a desired viewing angle. The lenticular screen 3 is a flat screen of substantially rectangular shape in which the lenticular lens 4 transmits the convergent light form the Fresnel-lens screen 8 to the black-stripes layer 5.

The black-stripes layer 5 shields any stray light from the light received from the lenticular lens 4 and transmits only the necessary light to the PDLC element 6. The PDLC element 6 is configured to diffuse the incident light from the optical engine 1, that is, the light received from the black-stripes layer 5, and transmit the diffused light to the light diffusion layer 7. The PDLC element 6 includes a first segmented-electrode 62a and a second segmented-electrode 62b, which together form a first electrode 62. The first segmented-electrode 62a and the second segmented-electrode 62b are transparent. Separate voltages can be applied to the first segmented-electrode 62a and the second segmented-electrode 62b. The PDLC element 6 receives the light from the black-stripes layer 5 and transmits the light to the light diffusion layer 7 after reducing the scintillation effect. The light with reduced scintillation effect is projected as an image to the viewer on the light diffusion layer 7.

Given below is the detailed description about the PDLC element 6. FIG. 3 is an enlarged side view of the PDLC element 6. The PDLC element 6 includes a pair of substrates 61 that are transparent, the first electrode 62, a second electrode 63 that is transparent and arranged to form a pair with the first electrode 62, a liquid-crystal diffusion layer 64, liquid crystal molecules 65 that are dispersed in the liquid-crystal diffusion layer 64, a polymer material 66 that is uniformly transparent, and a power supply circuit 70.

The first electrode 62 and the second electrode 63 sandwich the liquid-crystal diffusion layer 64, which is made of the polymer material 66 and the liquid crystal molecules 65. The first electrode 62 and the second electrode 63 are in turn sandwiched by the pair of substrates 61. In other words, the first electrode 62 is arranged-between one of the substrates 61 and the liquid-crystal diffusion layer 64. Subsequently, the second electrode 63 is arranged between the other substrate 61 and the liquid-crystal diffusion layer 64. That is, each of the first electrode 62 and the second electrode 63 is laid on either of the principle planes of the liquid-crystal diffusion layer 64. The power supply circuit 70 is connected to the first electrode 62 and the second electrode 63.

The pair of substrates 61 can be made of, for example, glass, plastic, or a polyethylene terephtalate (PET) film. The first electrode 62 and the second electrode 63 can be made of, for example, indium oxide (In₂O₃), indium tin oxide (ITO), or stannic oxide (SnO₂). As described above, the first electrode 62 includes the first segmented-electrode 62a and the second segmented-electrode 62b.

Both the first segmented-electrode 62a and the second segmented-electrode 62b are laid on separate portions of the same principle plane of the liquid-crystal diffusion layer 64.

The liquid crystal molecules 65 are dispersed, generally in a uniform manner, in the polymer material 66 of the liquid-crystal diffusion layer 64. The liquid crystal molecules 65 can be, for example, nematic liquid crystals. In the liquid-crystal diffusion layer 64, the incident light from the optical engine 1 is subjected to diffusion due to variation in scattering intensity of the light depending on the voltage that is applied to the liquid-crystal diffusion layer 64 via the first electrode 62 and the second electrode 63. The power supply circuit 70 applies a predetermined voltage to the first electrode 62 and the second electrode 63 based on a signal from a controlling unit (not shown).

When the power supply circuit 70 applies a voltage to the liquid-crystal diffusion layer 64, orientation of the liquid crystal molecules 65 varies depending on the applied voltage. The variation in orientation of the liquid crystal molecules 65 also causes variation in their refractive indices.

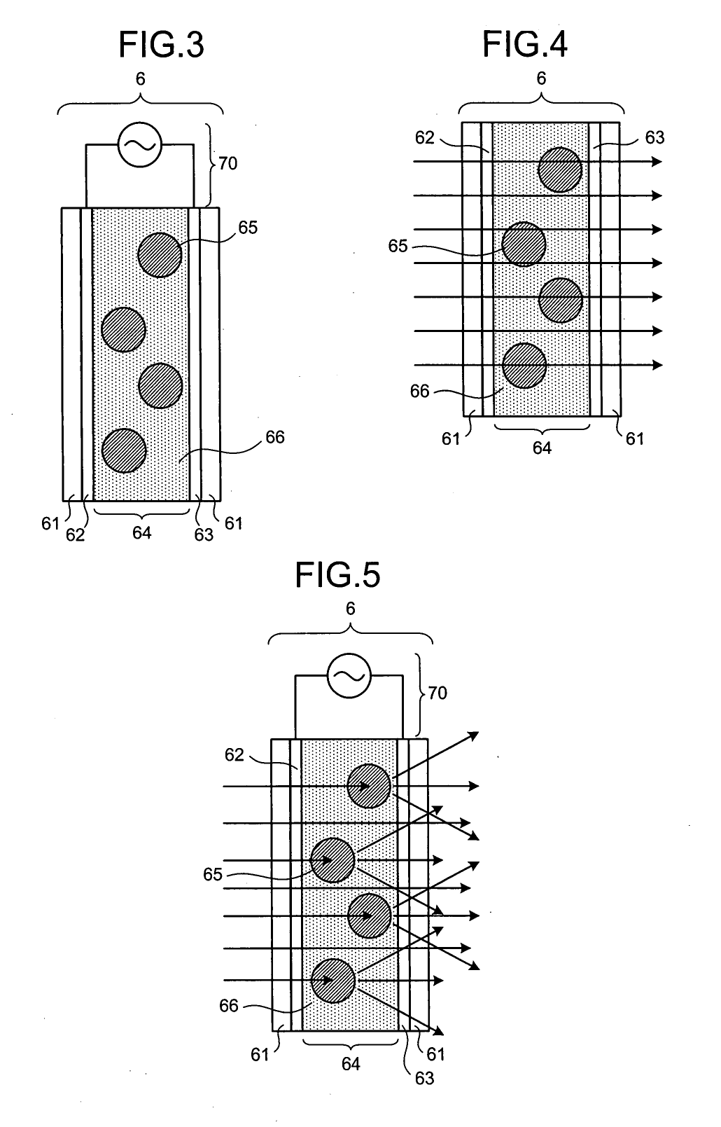

FIG. 4 is a schematic diagram depicting a status of light diffusion when no voltage is applied to the liquid-crystal diffusion layer 64. As shown in FIG. 4, when the refractive indices of the polymer material 66 and the liquid crystal molecules 65 are equal, the incident light to the liquid-crystal diffusion layer 64 travels straight without being diffused.

FIG. 5 is a schematic diagram depicting a status of light diffusion when a voltage is applied to the liquid-crystal diffusion layer 64. As shown in FIG. 5, when the refractive indices of the polymer material 66 and the liquid crystal molecules 65 are different, the incident light to the liquid-crystal diffusion layer 64 is diffused by the liquid crystal molecules 65. Thus, it is possible to manipulate the light diffusion characteristics of the PDLC element 6 (liquid-crystal diffusion layer 64) by controlling the voltage applied to the liquid-crystal diffusion layer 64.

The PDLC element 6 is configured such that when no voltage is applied to the first electrode 62 and the second electrode 63, the refractive indices of the polymer material 66 and the liquid crystal molecules 65 become equal, and when a voltage is applied to the first electrode 62 and the second electrode 63, the refractive indices of the polymer material 66 and the liquid crystal molecules 65 become different. In other words, when no voltage is applied to the liquid-crystal diffusion layer 64, the PDLC element 6 falls in a transparent state, while when a voltage is applied to the liquid-crystal diffusion layer 64, the PDLC element 6 falls in a diffused state of certain degree depending on the applied voltage.

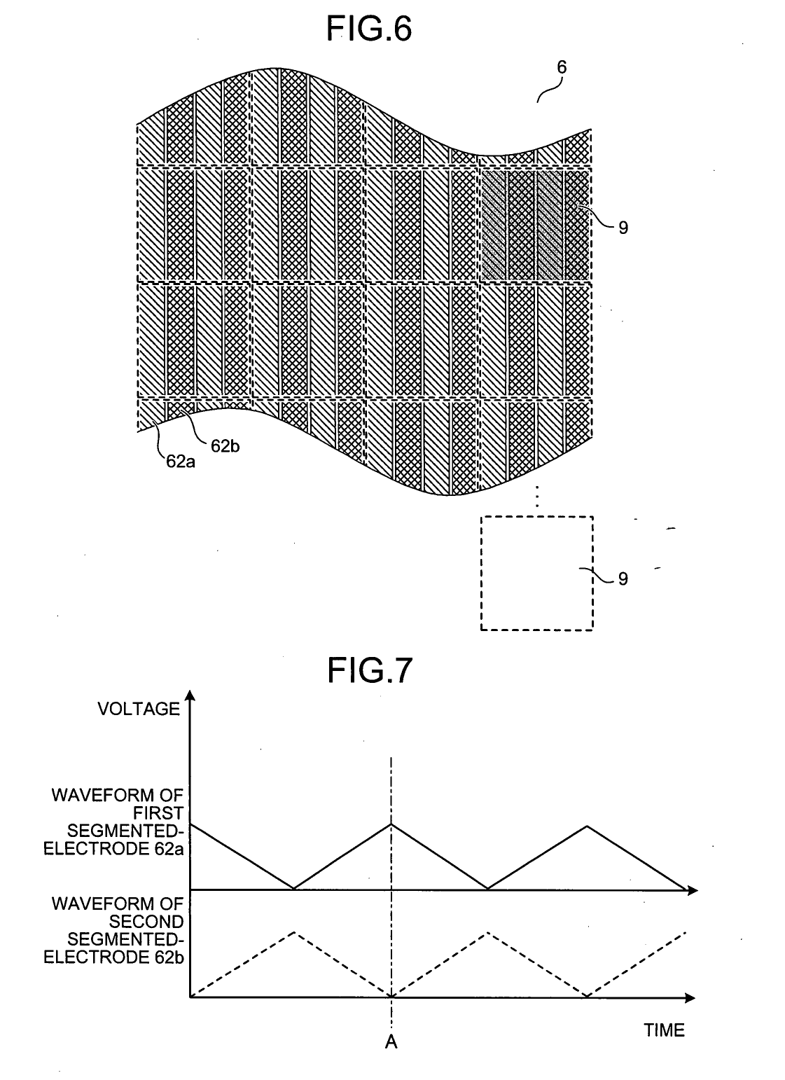

Given below is the description about the structure of the PDLC element 6. FIG. 6 is an enlarged perspective view explaining the detailed structure of the PDLC element 6. The arrangement of the first segmented-electrode 62a and the second segmented-electrode 62b on the PDLC element 6 is as shown in FIG. 6.

In the PDLC element 6, a plurality of pixels 9 are arranged to form a grid shown by a dotted line in FIG. 6. The first segmented-electrode 62a and the second segmented-electrode 62b form stripes, a width of which is narrower than the pixel-width of the pixels 9. Stripes of the first segmented-electrode 62a and stripes of the second segmented-electrode 62b are adjacently and alternatively laid on the PDLC element 6. A stripe of the first segmented-electrode 62a and a stripe of the second segmented-electrode 62b form a pair. The length direction of the stripes of the first segmented-electrode 62a and the second segmented-electrode 62b is adjusted to lie parallel to the vertical side of the pixels 9.

The first segmented-electrode 62a and the second segmented-electrode 62b are uniformly laid on the PDLC element 6 such that the number of stripes of the first segmented-electrode 62a is equal to the number of stripes of the second segmented-electrode 62b in each of the pixels 9.

In FIG. 6, two pairs of stripes of the first segmented-electrode 62a and the second segmented-electrode 62b are arranged in each of the pixels 9. That is, two stripes of the first segmented-electrode 62a lie alternately with respect to two stripes of the second segmented-electrode 62b in each of the pixels 9. Thus, a total of four stripes of segmented-electrodes in the sequence of 62a, 62b, 62a, and 62b having width smaller than the pixel-width of the pixels 9 are arranged in each of the pixels 9 and parallel to the vertical side of the pixels 9.

Furthermore, the first segmented-electrode 62a and the second segmented-electrode 62b occupy an equal area in each of the pixels 9. As described above, in FIG. 6, the same number (two) of pairs are arranged in each of the pixels 9 where the first segmented-electrode 62a and the second segmented-electrode 62b occupies equal area.

However, it is also possible to alternatively arrange three or more pairs in each of the pixels 9 as long as width of each of the first segmented-electrode 62a and the second segmented-electrode 62b is smaller than the pixel-width of each of the pixels 9.

Given below is the description about time waveforms formed when voltage is applied to the first segmented-electrode 62a and the second segmented-electrode 62b. FIG. 7 is a graph depicting an example of time waveforms when voltage is applied to the first segmented-electrode 62a and the second segmented-electrode 62b. The power supply circuit 70 applies two different voltages, one between the first segmented-electrode 62a and the second electrode 63, and the other between the second segmented-electrode 62b and the second electrode 63, such that the voltages can be separately and temporally varied to form two separate time waveforms.

As shown in the time waveforms in FIG. 7, the voltages applied by the power supply circuit 70 to the first segmented-electrode 62a and the second segmented-electrode 62b are adjusted such that the average amount of light diffusion (average scattering intensity of light) in the liquid-crystal diffusion layer 64 within each of the pixels 9 is maintained at a substantially constant value. In FIG. 7, the voltages applied to the first segmented-electrode 62a and the second segmented-electrode 62b are varied at a constant period such that their corresponding time waveforms shown as triangular waves are in an inverted relation with respect to each other.

For example, at a particular time ‘A’ shown in FIG. 7, a maximum voltage is applied to the first segmented-electrode 62a. As a result, there is maximum amount of light diffusion in the portion of the liquid-crystal diffusion layer 64 on which the first segmented-electrode 62a is laid on. On the other hand, at the time ‘A’, no voltage is applied to the second segmented-electrode 62b. As a result, there is no light diffusion in the portion of the liquid-crystal diffusion layer 64 on which the second segmented-electrode 62b is laid on. That is, the portion of the liquid-crystal diffusion layer 64 on which the second segmented-electrode 62b is laid on falls in a transparent state.

Given below is the sequence of operations performed in the display mechanism 2. The Fresnel-lens screen 8 converts the light emitted from the optical engine 1 into a parallel light flux and outputs the parallel light to the lenticular screen 3. An image is formed on the lenticular screen 3 by using the parallel light.

In the lenticular screen 3, the light sequentially transmits through the lenticular lens 4 that widens the viewing angle of the light, the black-stripes layer 5 that shields the stray light, the PDLC element 6, and the light diffusion layer 7. An image with a wide viewing angle in all directions is then projected to the viewer.

In the lenticular screen 3, mainly due to the light fluctuation in the light diffusion layer 7, the light diffusion characteristics slightly vary corresponding to subtle variations in the position of light diffusion. Because the light diffusion characteristics slightly vary at different positions, minute shades occur on the lenticular screen 3 depending on the direction from which the lenticular screen 3 is viewed. The shades on the lenticular screen 3 are visible to the viewer as glares. Such appearance of glares is called the scintillation effect. The generating pattern of the scintillation effect varies according to the variation in the light diffusion characteristics of the lenticular screen 3.

To solve the problem of the scintillation effect, the light diffusion characteristics of the lenticular screen 3 are subjected to temporal variation by combining the light diffusion layer 7 and the PDLC element 6, whose light diffusion characteristics can be varied by applying a voltage. As a result, the generating pattern of the scintillation effect also varies temporally thereby averaging out the generating pattern over a period. Thus, the scintillation effect visible to naked eyes can be effectively reduced.

Reducing the visible scintillation effect by the method of time-averaging is not meant to reduce the scintillation effect at a particular point of time. However, by time-averaging the generating pattern of the scintillation effect, it is possible to make the scintillation effect less visible to naked eyes. As described above, the scintillation effect occurring in the image projector 100 is effectively reduced by implementing the method of time-averaging. Hence, even if a laser-light source that causes more scintillation effect is used in the image projector 100, it is possible to effectively reduce the scintillation effect similar to when the supervoltage mercury lamp is used.

Consider a case in which the method of time-averaging to reduce the scintillation effect is implemented without using the first segmented-electrode 62a and the second-segmented electrode 62b in the PDLC element 6. As a result, the brightness of the lenticular screen 3 keeps on varying depending on the variation in the light diffusion characteristics. That is, the more the light diffusion in the lenticular screen 3, the more the widening of the viewing angle thereby decreasing the light transmitting out of the lenticular screen 3. In other words, when the light diffusion in the lenticular screen 3 is strong, the projected image on the lenticular screen 3 becomes dark. On the other hand, when the light diffusion in the lenticular screen 3 is weak, the projected image on the lenticular screen 3 becomes bright. To avoid such problem, the first-segmented electrode 62a and the second-segmented electrode 62b are arranged in the PDLC element 6 such that the brightness of the screen is kept constant even when the light diffusion characteristics vary temporally.

Consider another case in which a PDLC element not including any segmented-electrodes is used in an image projector of a time-sharing display type. Such an image projector includes a single-chip optical modulator that implements a time sharing method in which the white light is divided into the light of three primary colors of red (R), green (G), and blue (B) to form a single-color image in each primary color. If the light diffusion characteristics of the screen of such an image projector are subjected to temporal variation, same as described above in case of the lenticular screen 3, then the light diffusion characteristics differ depending on the voltage applied at the time of displaying the image in each primary color. That causes unbalance of the brightness in the image signals corresponding to the primary colors thereby failing to display the image with its original colors.

Usually, the color switching between red (R), green (G), and blue (B) in the time sharing method is performed at least three times faster than the frequency of an image frame. Moreover, to prevent any color breakup caused by the color switching, the color switching is sometimes performed four to six times faster than the frequency of an image frame. If the color switching is performed four to six times faster than the frequency of an image frame, a usual liquid crystal material having low response speed fails to keep up with the high-speed color switching.

To solve such a problem and display a proper image according to the image signals, a predetermined signal processing can be performed on the image signals by taking into consideration the light diffusion characteristics of the PDLC element not including any segmented-electrodes. However, such signal processing of the image signals consumes valuable time. Moreover, it is also necessary to synchronize the timing of displaying the image and the timing of applying voltage to the PDLC element not including any segmented-electrodes. Hence, many complications are involved in controlling the image projector to display an image with desired colors.

However, the structure of the PDLC element 6 saves all such trouble. That is, even as the light diffusion characteristics at the first-segmented electrode 62a and the second-segmented electrode 62b keep varying temporally, the voltages applied to the first segmented-electrode 62a and the second segmented-electrode 62b are adjusted such that the average amount of light diffusion within each of the pixels 9, which is the smallest unit of an image, is maintained at a constant value. That helps in keeping the brightness of the screen constant even when the light diffusion characteristics vary temporally. Furthermore, the scintillation effect can be effectively reduced even by using only one unit of the PDLC element 6 that is easy-to-control and low-cost.

In this way, the image projector 100 can easily display an image with its original colors without performing any special signal processing on the image signals, or without synchronizing the timing of applying voltage to the PDLC element 6 and the timing of displaying the image.

Instead of arranging two types of segmented-electrodes, viz., the first segmented-electrode 62a and the second segmented-electrode 62b, in the PDLC element 6, it is also possible to arrange three or more types of segmented-electrodes. In that case also, the brightness of the screen can be kept constant even if the light diffusion characteristics vary temporally. Furthermore, the scintillation effect can also be effectively reduced.

However, to simplify the hard-wiring in the PDLC element 6, it is recommended to use two types of segmented-electrodes, viz., the first segmented-electrode 62a and the second segmented-electrode 62b, that are arranged to form stripes over the pixels 9 as shown in FIG. 6.

The PDLC element 6 and the lenticular lens 4 can also be arranged such that the first segmented-electrode 62a and the second segmented-electrode 62b in the PDLC element 6 are orthogonal to the group of cylindrical lenses arranged in the lenticular lens 4. Such configuration helps in preventing moire fringes between the PDLC element 6 and the lenticular lens 4.

The time waveforms of the voltage applied to the PDLC element 6 are shown as triangular waves in FIG. 7. Instead, the time waveforms of the voltage can be shown as sine waves or rectangular waves.

As described above, it is possible to variably adjust the light diffusion characteristics in the display mechanism 2. That feature can be used to externally adjust the variation in the overall light diffusion characteristics of the lenticular screen 3 such that images with the best viewing angle depending on the external environment or viewing position are constantly provided to the viewer. For that, a new unit can be added in the display mechanism 2 to variably adjust the light diffusing characteristics. The new unit can be configured such that the average value of the light diffusion characteristics within the area of each pixel of an image can be externally adjusted. Thus, based on the instructions that are externally input, the display mechanism 2 can control the PDLC element 6 for particular light diffusion characteristics.

Although pairs of stripes of the first segmented-electrode 62a and the second segmented-electrode 62b are arranged on the PDLC element 6 such that the first segmented-electrode 62a and the second segmented-electrode 62b occupy equal area in each of the pixels 9, the first segmented-electrode 62a and the second segmented-electrode 62b can be lied in any arrangement. If the area occupied by the first segmented-electrode 62a is not equal to the area occupied by the second segmented-electrode 62b in each of the pixels 9, the amount of voltage proportionate to the corresponding areas occupied by the first segmented-electrode 62a and the second segmented-electrode 62b can be applied such that the light diffusion characteristics of the PDLC element 6 are controlled to maintain constant brightness of the screen.

As described above, the main light source 20 of the light source device 10 includes the lamp-light source 11. However, a light emitting diode (LCD) or a laser-light source can be used instead of the lamp-light source 11 in the main light source 20.

As described above, because the light diffusion characteristics of the lenticular screen 3 are subjected to temporal variation, the generating pattern of the scintillation effect can be temporally averaged out. Thus, the scintillation effect can be easily reduced without any complicated configuration of the lenticular screen 3.

According to an embodiment of the present invention, the voltages applied separately to the first segmented-electrode 62a and the second segmented-electrode 62b are adjusted such that the average amount of light diffusion within each of the pixels 9 is maintained at a uniform value. As a result, the scintillation effect in the displayed image can be effectively reduced without affecting the color balance and brightness.

Moreover, a method of time-averaging to reduce the scintillation effect is implemented using the first segmented-electrode 62a and the second-segmented electrode 62b in the PDLC element 6. Similarly, even if the same method is implemented in an image projector of a time-sharing display type, the scintillation effect in the displayed image can be effectively reduced without affecting the color balance and brightness.

Furthermore, the hard-wiring in the PDLC element 6 is simplified by using the first segmented-electrode 62a and the second segmented-electrode 62b. That enables to easily apply voltages to the first segmented-electrode 62a and the second segmented-electrode 62b.

Moreover, multiple pairs of the first segmented-electrode 62a and the second segmented-electrode 62b, whose width is smaller than the pixel-width of the pixels 9, are adjacently and alternatively laid on the PDLC element 6. That is an effective way to arrange the first segmented-electrode 62a and the second segmented-electrode 62b in the liquid-crystal diffusion layer 64.

Furthermore, the first segmented-electrode 62a and the second segmented-electrode 62b are arranged such that the first segmented-electrode 62a and the second segmented-electrode 62b occupy equal area in each of the pixels 9. Such arrangement helps to temporally average out the generating pattern of the scintillation effect thereby effectively reducing the scintillation effect. The voltage applied to the first segmented-electrode 62a and the second segmented-electrode 62b can also be controlled easily.

Moreover, the first segmented-electrode 62a and the second segmented-electrode 62b are uniformly laid on the PDLC element 6. Such arrangement helps to temporally average out the generating pattern of the scintillation effect thereby effectively reducing the scintillation effect.

Furthermore, the overall light diffusing characteristics of the lenticular screen 3 in the display mechanism 2 can be variably adjusted depending on the external environment or viewing position. Thus, images with the best viewing angle can be constantly provided to the viewer.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A light diffusion element for use in a screen for displaying an image, the light diffusion element comprising:
a liquid-crystal diffusion layer made of a high polymer containing liquid crystal molecules dispersed therein, the liquid crystal molecules variably diffusing an amount of light passing through the liquid-crystal diffusion layer depending on a voltage applied to the liquid-crystal diffusion layer;
a first electrode that is laid on a first principle plane of the liquid-crystal diffusion layer and includes a first segmented-electrode and a second segmented-electrode, wherein the first segmented-electrode and the second segmented-electrode are included in each pixel of the image;
a second electrode that is laid on a second principle plane of the liquid-crystal diffusion layer opposite to the first principle plane;
a voltage applying unit that is configured to generate and apply a first voltage between the first segmented-electrode and the second electrode, and a second voltage between the second segmented-electrode and the second electrode; and
a voltage changing unit that separately and temporally varies the first voltage and the second voltage.

2. The light diffusion element according to claim 1, wherein the voltage changing unit varies the first voltage and the second voltage in a cycle so that an average amount of light diffusion in each pixel of the image is maintained at a constant value.

3. The light diffusion element according to claim 1, wherein the first segmented-electrode and the second electrode form stripes.

4. The light diffusion element according to claim 3, wherein a width of each stripe of the first segmented-electrode and a width of each stripe of the second segmented-electrode are narrower than a pixel-width of each pixel in the image, and a stripe of the first segmented-electrode and a stripe of the second segmented-electrode are adjacently and alternatively arranged to form a pair such that a plurality of the pairs are arranged within each pixel.

5. The light diffusion element according to claim 1, wherein the first segmented-electrode and the second segmented-electrode are arranged uniformly in each pixel of the image, and the first segmented-electrode and the second segmented-electrode occupy equal area in each pixel.

6. The light diffusion element according to claim 2, wherein the voltage changing unit varies the first voltage and the second voltage whereby the average amount of light diffusion is adjusted to a value that is received from outside.

7. A screen that displays an image by using a light projected on the screen, the screen comprising a light diffusion element including
a liquid-crystal diffusion layer made of a high polymer containing liquid crystal molecules dispersed therein, the liquid crystal molecules variably diffusing an amount of light passing through the liquid-crystal diffusion layer depending on a voltage applied to the liquid-crystal diffusion layer;
a first electrode that is laid on a first principle plane of the liquid-crystal diffusion layer and includes a first segmented-electrode and a second segmented-electrode, wherein the first segmented-electrode and the second segmented-electrode are included in each pixel of the image;
a second electrode that is laid on a second principle plane of the liquid-crystal diffusion layer opposite to the first principle plane;
a voltage applying unit that is configured to generate and apply a first voltage between the first segmented-electrode and the second electrode, and a second voltage between the second segmented-electrode and the second electrode; and
a voltage changing unit that separately and temporally varies the first voltage and the second voltage.

8. An image projector comprising:
a light source that emits a light;
a light focusing unit that makes the light coming from the light source to be a substantially parallel light flux, and focuses the substantially parallel light flux on a target surface located on an axis of the substantially parallel light flux;
an image projection unit that modulates and spreads the substantially parallel light flux focused on the target surface, and projects modulated and spread light; and
a screen that displays an image based on the light coming from the image projection unit, the screen including
a liquid-crystal diffusion layer made of a high polymer containing liquid crystal molecules dispersed therein, the liquid crystal molecules variably diffusing an amount of light passing through the liquid-crystal diffusion layer depending on a voltage applied to the liquid-crystal diffusion layer;
a first electrode that is laid on a first principle plane of the liquid-crystal diffusion layer and includes a first segmented-electrode and a second segmented-electrode, wherein the first segmented-electrode and the second segmented-electrode are included in each pixel of the image;
a second electrode that is laid on a second principle plane of the liquid-crystal diffusion layer opposite to the first principle plane;
a voltage applying unit that is configured to generate and apply a first voltage between the first segmented-electrode and the second electrode, and a second voltage between the second segmented-electrode and the second electrode; and
a voltage changing unit that separately and temporally varies the first voltage and the second voltage.
